(19) United States
(12) Patent Application Publication
(10) Pub. No.: US 2007/0263648 A1
(43) Pub. Date: Nov. 15, 2007

(54) Method for searching and managing planned community information

(76) Inventor: Davis M. Driver, Scottsdale, AZ (US)

Correspondence Address: ETHERTON LAW GROUP, LLC, 5555 E. VAN BUREN STREET, SUITE 100, PHOENIX, AZ, 85008, US

(21) Appl. No.: 11/803,200

(22) Filed: May 10, 2007

Related U.S. Application Data
(60) Provisional application No. 60/799,454, filed on May 10, 2006.

(51) Int. Cl. H04L 12/56

(52) U.S. Cl. 370/411

(57) ABSTRACT

The present invention is a web-based method for collecting and searching data about a plurality of planned communities that enables buyers to search the data by one or more desired planned community characteristics, particularly those amenities that are peculiar to luxury homes and homesites. In the preferred embodiment, the planned community data is aggregated into a single database and updated automatically. The method pairs front-end and back-end data in a database, so that planned communities' internal sales and marketing operations can be coordinated with the planned community data seen y buyers. The data are displayed on a website, and certain data are available to the public, while other data are accessible to authorized users only.

### CROSS-REFERENCE TO RELATED APPLICATIONS

This application claims the benefit of co-pending U.S. Provisional Application No. 60/799,454 filed May 10, 2006, which is incorporated by reference.

### FIELD OF INVENTION

The present invention relates generally to a method and database for collecting, organizing, searching, displaying and managing information about planned residential communities. The present invention relates more specifically to a web-based computer method and database that centralizes data related to the marketing and sale of a residential property in planned communities.

### BACKGROUND

There are at least two thousand planned residential community developments in the United States and thousands more worldwide. These planned communities are also referred to in the industry as master planned communities, and are generally combinations of diverse land uses such as housing, recreation and commercial units in a self-contained development on a continuous portion of land. The planned communities may provide certain benefits to the residents, such as a communal swimming pool for community members only or a members-only recreation center, which are not found in conventional neighborhoods developed under only zoning laws and neighborhood covenants. Luxury planned communities may provide owners unusual additional benefits, such as golf course memberships, private lake privileges, private clubs, or private airstrips, each perhaps with a variety of membership levels. These luxury benefits are not common, but they are a defining purchase factor to many wealthy purchasers. The luxury benefits are ever more popular to the millions of American “baby boomers” who are reaching retirement age and want to relocate to planned communities that offer their desired mix of amenities and other characteristics.

Historically, most buyers decide where they want to live and then look for homes in that geographical area. The geographical area is defined herein as a region having common living characteristics. If it is a metropolitan area, the geographical area searched by the buyer may include portions of several cities and counties. If it is a beach area, the geographical area may be limited to the desired beach. For that reason, real estate databases are invariably set up such that only homes in a certain geographic area can be searched, such as the well-known Multiple Listing Service (“MLS”) which is a collection of data on individual homes in a specific geographical locale. That is, for homes in Long Beach, Calif., the buyer searches databases containing homes in the Long Beach area and surrounds. Similarly, for homes in Miami, Fla., the buyer searches databases containing homes in the Miami area and surrounds.

However, the characteristics of the planned community are so important to some purchasers that they may take precedence over the location of the home being purchased. Unfortunately, there is no real-time, central source for information about planned communities from different geographical areas. This is problematic for buyers who want to find the right planned community first and then focus on finding the right home in that planned community, regardless of where the planned community is located. It would be desirable to be able to search a single database of planned communities from around the world to find ones with desired characteristics, without having to conduct multiple separate searches in multiple location-specific databases.

The search options available today largely force buyers to attack the problem in reverse, searching multiple location-specific databases for homes, researching the planned communities the found homes are in, and then comparing multiple planned communities results from the multiple different searches. This is highly inefficient. Another approach is to buy magazines aimed at a given demographics, such as golfers, boaters, skiers or some other group of people who favor some other particular recreational activity. These publications typically offer advertisements or lists of communities appealing to the demographic, but even these are organized according to what state they are in. Another approach is to turn to the internet to conduct these searches. One problem with this approach is that internet searches using existing search tools do not have good sorting or filtering capability, and often return hundreds of results that must be culled through to find the desired information. These searches tend to drive buyers to individual properties without regard to whether they are in a planned community that fits the buyer's desires, or to real estate agents or the brokerage firms they work for. As a result, the buyer has the same problem he has if he goes the magazine route: a very broad a list of properties, not sorted by planned community having certain characteristics. It would be desirable to be able to search a single database of planned communities to find ones with desired characteristics, without having to conduct multiple searches in multiple location-specific databases.

MLS search criteria do not incorporate fields for characteristics of the planned communities that are of interest to luxury buyers. And, while comments can be entered into the MLS that may set forth special characteristics of the community, such entry results in non-standardized entries that are effectively unsearchable. It would be desirable to be able to search planned communities by characteristics that are desired by the buyer. It would also be desirable to enable easy comparison shopping for the best communities by allowing a user to search, filter and sort that information by many community and property characteristics other than geographical location and recreational activity. It would also be desirable to enable a user to search by characteristics that are individually chosen by a user to fit his own criteria. It would also be desirable to be able to search that information by property characteristics, regardless of location.

To entice buyers to a planned community, the developer of a planned community goes to great expense to create marketing information, usually including photographs and factual details about the planned community. Distributing that information to potential buyers can be a challenge and, until the Internet came along, developers resorted to advertisements in magazines and newspapers and direct mail. It would be desirable to distribute marketing material more easily. Another problem facing developers is the need for an organized way to manage the marketing and sale activities of the homes and homesites in the planned community. Collections of relevant information are often deployed in slightly different, parallel systems, both internal (sales and accounting departments, for example) and external (MLS and the county tax records, for example), which do not communicate easily with one another. This requires duplicate work to keep them updated and makes it much more difficult for the different databases to be synchronized. Further, the internal operation of the planned community's sales stems from a similar set of data to the outbound flow of marketing and sales information. Consequently, it would be desirable to coordinate planned communities' internal sales and marketing operations with outbound sales and marketing information flows. That is, it would be desirable to have a single system for coordinating all the information related to marketing and selling a home or homesite in a planned community.

### SUMMARY OF THE INVENTION

The present invention is a web-based method for collecting and searching data about a plurality of planned communities that enables users to search the data by one or more desired planned community characteristics, particularly those amenities that are peculiar to luxury homes and homesites. In the preferred embodiment, the planned community data from multiple communities is aggregated into a single database and updated automatically, and updates are displayed in real-time on the internet. The method pairs front-end and back-end data in a single database, so that planned communities' internal sales and marketing operations can be coordinated with the planned community data seen by buyers. The data are displayed on a website, and certain data are available to the public, while other data are accessible to authorized users only.

### BRIEF DESCRIPTION OF THE DRAWINGS

FIG. 1 is a schematic illustration of the relationships of the database and users of the present invention.

FIG. 2 is a schematic illustration of planned community website information being automatically transmitted over the network to the planned community data table.

FIG. 3 is one embodiment of a website enabling a search for planned communities that have a desired amenity.

FIG. 4 is one embodiment of a website enabling a search for homes or homesites in planned communities that have golf memberships.

### DETAILED DESCRIPTION OF THE INVENTION

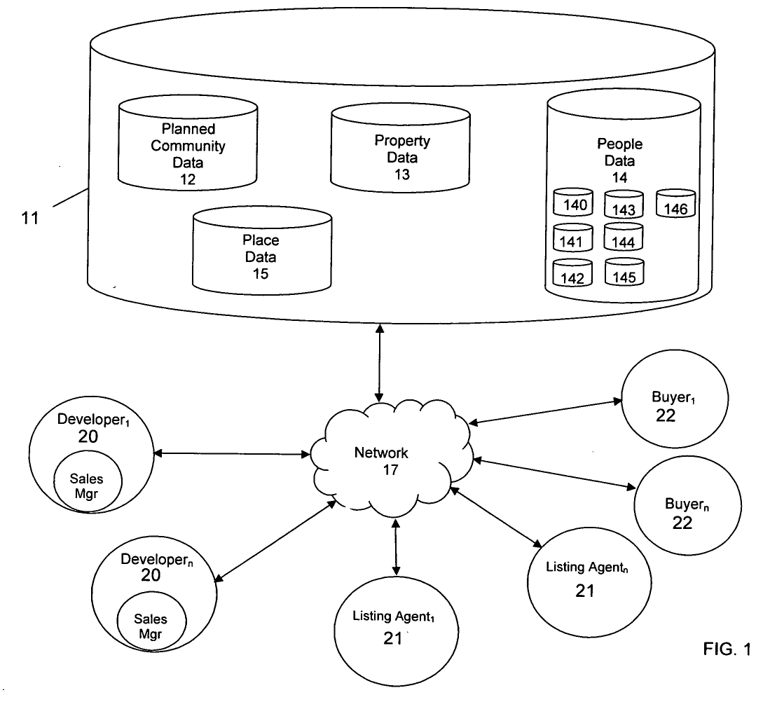

The present invention is business process software that provides an overarching, connected system of information tables and websites to an entire industry with all the business development, business management, information management and communication tools and standard practices the industry needs in one streamlined system. While the preferred embodiment is described in terms of planned communities, it can be similarly adapted for other industries. FIG. 1 is a schematic illustration of the system in general. The invention comprises a database 11 with at least planned community data 12, property data 13, and people data 14. The people data 14 may further comprise owner data 141, buyer data 142, lender data 143, builder data 144 or that of other people commonly connected to planned communities. As used herein, database 11 means one or more data tables that are under common control. The database 11 preferably resides on a single computer, but may be distributed over a number of computers. More specifically, the database is not solely comprised of links to data tables or websites that are not under the common control. While these data on FIG. 1 are shown with like data grouped together in a single data table, this is for clarity in illustration only; the data my be combined in a single data table, or distributed over many data tables or databases, and the planned community, property, and people data may be commingled.

A “planned community” is a contiguous portion of land that, before being built, is planned with combinations of diverse land uses such as housing, recreation and commercial units in one self-contained development. Usually a planned community is planned and initially owned by a single land development company, referred to herein as a developer. The planned community data is preferably a comprehensive profile of the planned community that includes physical, location, financial and legal characteristics about the planned community and the surrounding area that could be of interest to a potential purchaser.

In the preferred embodiment, templates are used to standardize the data by collecting complete and uniform data about each planned community. The planned community data 12 includes at least one luxury feature, referred to herein as a planned community amenity, such as golf, tennis, swimming, fitness, equestrian facility (with or without private boarding), concierge, spa, fishing (fresh or salt water), fresh water boating (sailing, power boating, or deep water yachting) salt water boating (sailing, power boating, or deep water yachting), hunting, shooting (trap, skeet, sporting clays, shooting range), basketball, volleyball, squash, racquetball, water skiing, snow skiing, surfing, scuba, snorkeling, hiking, biking, fine dining, casual dining, or other social activities for the young and old. The planned community data 12 may also include a copy of the developer's website of its planned community.

In addition to the amenity, the planned community data 12 preferably includes a brief narrative description; geographic location; age of development; whether there is a homeowner association; membership costs and regulations; physical characteristics of the development such as size and elevation; floor plans available; architectural style; surrounding area demographics; surrounding area attractions including dining and shopping, major league and college sports teams, cultural institutions such as symphony, opera, museums, libraries, theatres; major annual events and festivals; nearby hospitals; available public and private transportation; climate and weather; public and private schools; tax information; and houses of worship. Planned community data 12 may also include planned community membership, which is the owner's level of activity privileges including, access to golf, access to an airstrip, access to ski runs, access and management to horses, access to dining, access to boat mooring, or other private clubs. The database 11 may also include place data 15, which comprise locations that are inside or outside the planned community, but that are not the planned community or a home or homesite therein. Provisions may be made to allow a developer's club management department to keep all its records in this database, as well.

Appendix A lists many aspects that could be incorporated in the planned community data.

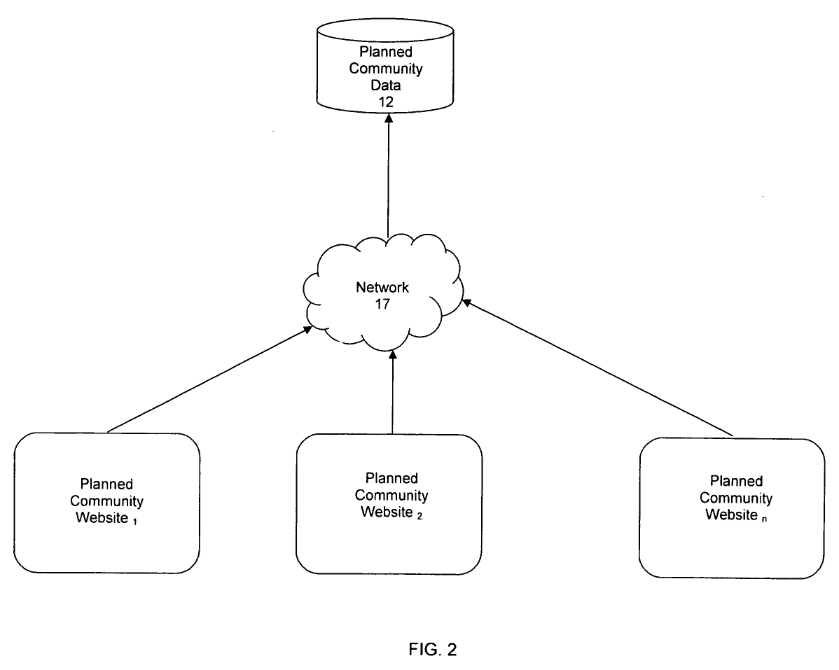

Planned community data 12 is provided by a plurality of developers₁₋ₙ the developer's agent(s), in which each developer provides data about its specific planned community. The planned community data 12 is provided in electronic format to the database 11, and more preferably via a public network such as the internet, although private networks may suffice. While the planned community data 12 is relatively static, preferably it is automatically updated whenever the developer updates its data, without extra effort on the part of the developer. The updates can be done dynamically as the data are changed, or periodically in batches. FIG. 2 is a schematic illustration of planned community website information being automatically transmitted over the network to the planned community data when the planned community source data changes.

Because the database 11 aggregates planned community data 12 from a plurality of developers, the data can be accessed and mined to provide reports with any permutation of the aggregated data therein, resulting in industry reports heretofore unavailable. In practice, the reports of aggregated data will likely be made anonymous so that competitors cannot view specific information about each other.

As used herein, a property is the subject of the sale, and includes raw land (referred to herein as a “homesite”) and a home (which includes the land it sits on). The property data 13 includes individual, historic records on each property within a development. It includes the basic, common information found in MLS databases such as the size of a home, the county assessor's number, number of bedrooms, how many cars can be parked in the home's garage, whether it has a pool and a spa, etc., as well as uncommon information that is useful for higher-level analysis and marketing that is not found in MLS. This uncommon information is preferably relevant to luxury homes buyers. It may include, for example, the view for each home or homesite, where view means any appealing visual appearance seen when looking out from the homesite, which may be of any attraction, including a golf course; a mountain; ski runs; water, such as a lake, bay, river, or ocean; city lights; forest; desert; city skyline. The property data 13 also preferably includes location relative to the amenity; homesite envelope size; home size; direction homesite faces; architectural style; architect; community membership availability; address or other unique identifier; sale status; listing agent; buyer agent; owner; or price, both offer price and purchase price. Further, the property data may include the entire design, construction and transaction history and related documents, such as design review board reports, standard Realtor® contracts, title and escrow forms, and recordation forms. Provisions may be made to allow a homeowners' association to keep all its records in this database, as well.

In the preferred embodiment, templates are used to standardize the data by collecting complete and uniform data about each property. The property data changes relatively frequently, and preferably it is automatically updated whenever the developer updates its data, without extra effort on the part of the developer. The updates can be done dynamically as the data are changed, or periodically in batches. Appendix B provides a more detailed list about the uncommon information provided about each property in the development.

Because the database 11 aggregates property data 13 from a plurality of developers, the data can be accessed and mined to provide reports with any permutation of the aggregated data therein, resulting in industry reports heretofore unavailable. For example, a using transaction history data, reports can be generated showing industry-wide trends in sales of golf communities across multiple planned communities. In practice, the reports of aggregated data will likely be made anonymous so that competitors cannot view specific information about each other.

The people data 14 includes information about people associated with the planned community and sale of the properties, such as listing agent data 140, owner data 141, buyer data 142, buyer agent data 143, lender data 144, builder data 145, and developer data 146, which includes developer employees such as sales managers. The people data 14 characteristics include name, contact, calendar and scheduling information. The people data 14 may be provided by or integrated with a third-party customer relations management software application. Provisions may be made to allow a developer's human resources department to keep all its records in this database, as well.

Listing agents includes any person or entity holding a listing for the available property, including the owner and real estate agents and brokers who may or may not be Realtors(&. The listing agent characteristics include the listing agent's name and contact information and listed properties for the listed agent, and preferably include a more detailed profile, with the sales executive's photograph, experience, and licenses. The listed properties data may further include available, pending and sold listed properties, as well as expired listings. Preferably the listing agent characteristics include the listing agent's schedule for showing listed property. This enables the developer's sales manager to conveniently monitor sales progress.

The owner characteristics include any person on entity that has legal title to the property, including the developer, resident, investor, trust, or financial institution, such as a bank. The database 11 may also include characteristics about lending agents, such as those currently holding the mortgage, or those interested in financing new purchases. As used herein buyer includes prospective buyers, buyers in process, and buyers who have completed a purchase. Buyer characteristics may include name and contact information, and amenity desired. The buyer agent includes any person or entity acting on behalf of a Buyer, including the buyer itself. Buyer agent characteristics include name and contact information; and the amenity desired by the represented buyer. The buyer data for prospective buyers may be transmitted to a developer and used as a lead generation. Conversely, the buyer data for those buyers who have completed a purchase may be made available to other such buyers for social networking or forming a buyers club. Finally, people data 14 preferably includes one or more builder characteristics, such as name and contact information or addresses of homes built by builder.

The database 11 may also include an integrated calendar so that the schedules, contacts, and other events may be recorded and seen by the people involved in the real estate transaction. Further, the system may include standard practices, policies and procedures for those involved in the real estate transaction. A forms library may be integrated with the templates so that data needs to be entered only once to be populate all the requisite forms and schedules.

The database 11 is accessed from the network 17. If the internet is the network, any person can access the database 11 though a conventional website, although access may be limited for certain types of users.

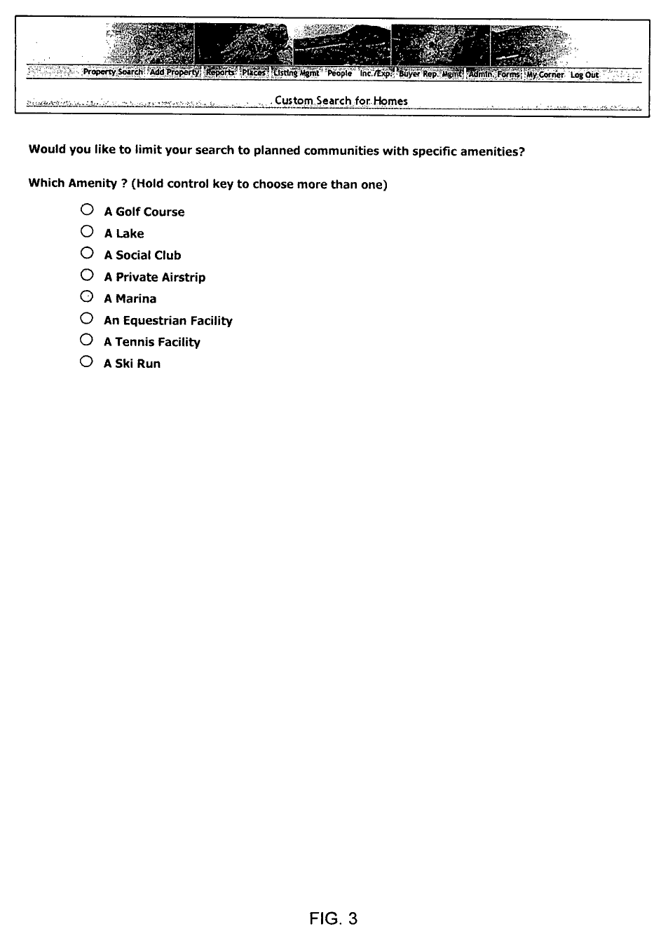

The invention has two primary groups of users: public and private users. The public users have access to only limited portions of the data that are generally not proprietary or sensitive, namely the general data about the planned communities and the properties available therein. Public users can search for planned communities on a relatively detailed comparative shopping basis using certain criteria established by the person interested in acquiring property in a planned community. The criteria are self-selected by the user from a substantial list provided at the website. FIG. 3 is one embodiment of a website enabling a search for planned communities that have a desired amenity.

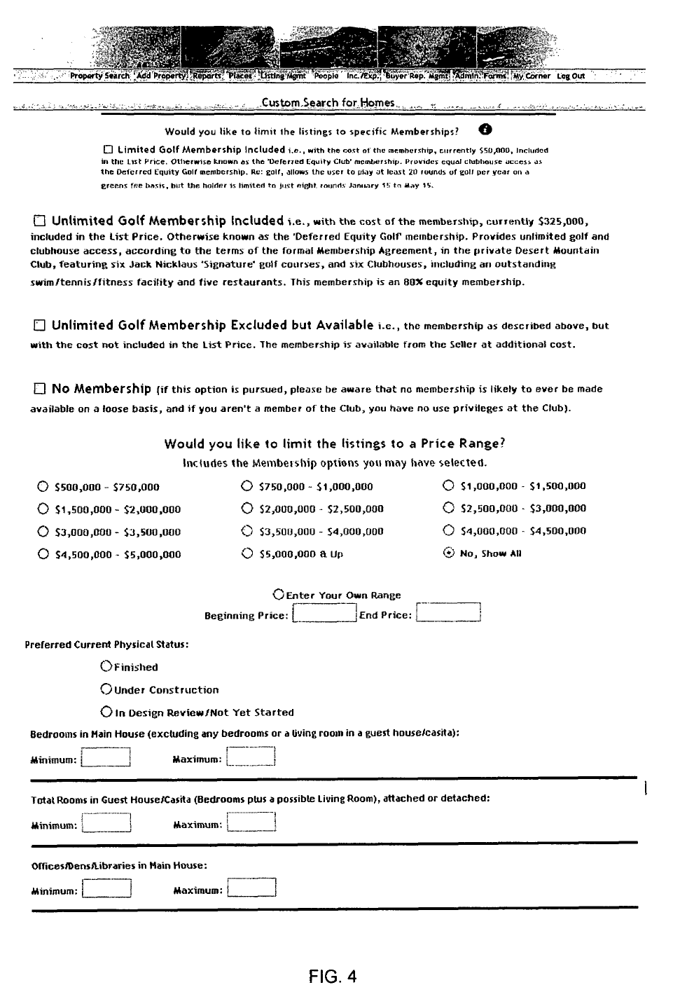

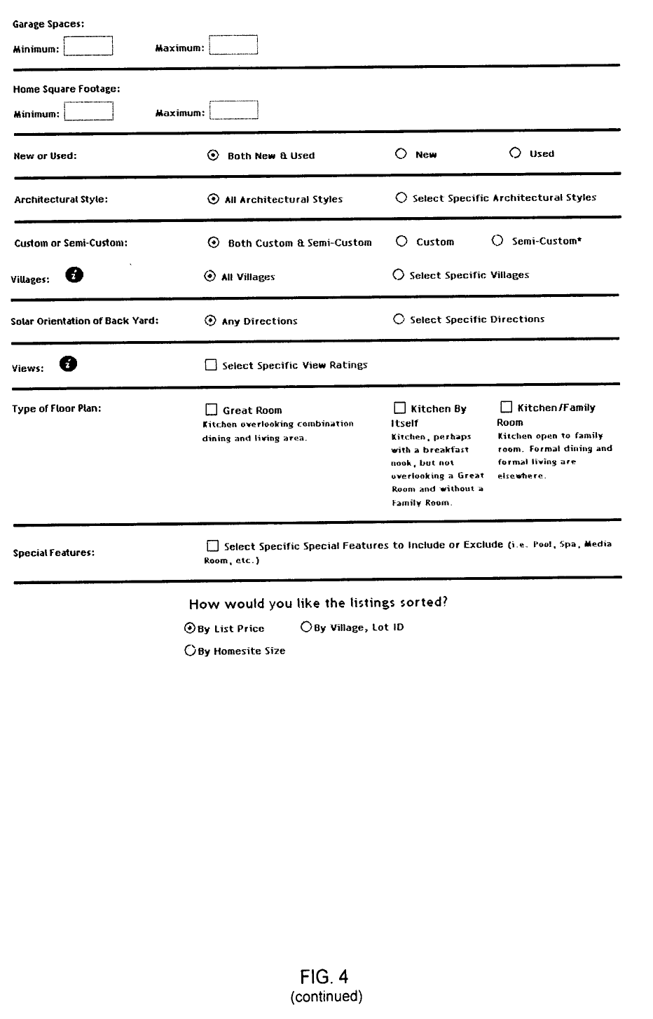

FIG. 4 is one embodiment of a website enabling a search for properties in planned communities that have golf memberships. Other public users include the developers, buyers agents, property owners, builders and retail and institutional lenders.

Private users have access to more portions of the data than the public users, some of which are generally proprietary or sensitive, such as the specific price history of a property or the personal schedule of a listing agent. For example, portions of the database, such as certain people data or past property sales histories, may be accessible by permission only. Typically the private users will be the developers and their employees and listing agents.

The search results are available in easy-to-read reports, which can be displayed, printed or stored. Preferably the searches and results are web accessible from stationary and mobile computers.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A method for managing information about planned communities comprising:
a) collecting data about a plurality of planned communities in a database;
b) accessing the data from a computer network;
c) searching the data;
d) displaying the results of the search.

2. The method of claim 1 wherein the data comprises:
a) one or more planned community characteristics including an amenity.

3. The method of claim 2 wherein the data further comprises:
a) one or more available property characteristics about at least one property available in each of one or more of the planned communities.

4. The method of claim 2 wherein the data further comprises:
a) one or more listing agent characteristics about a listing agent holding a listing for at least one of the available properties;
b) one or more owner characteristics;
c) one or more buyer agent characteristics;
d) one or more lending agents characteristics; and
e) one or more builder characteristics.

5. The method of claim 2 wherein the amenity further comprises one or more of:
a) a golf course;
b) a lake;
c) a social club;
d) a private airstrip;
e) a marina;
f) an equestrian facility;
g) a tennis facility; or
h) a ski run.

6. The method of claim 3 wherein the available property characteristics includes one or more of the following:
a) a location relative to the amenity;
b) a homesite envelope size;
c) a home size;
d) a direction the homesite faces;
e) an architectural style;
f) an architect;
g) a community membership availability;
h) a view;
i) an address or other unique identifier;
j) a sale status;
k) a listing agent;
l) a buyer agent;
m) an owner;
n) an offer price; or
o) a purchase price.

7. The method of claim 4 wherein the listing agent characteristics includes one or more of the following:
a) a listing agent name and contact information;
b) a listed properties for the listed agent, further comprising at least one of:
c) an available listed property;
d) a pending listed property;
e) a sold listed property;
f) an expired listed property; and
g) a schedule for showing listed property.

8. The method of claim 4 wherein the owner characteristics includes one or more of the following:
a) an owner name and contact information; or
b) an address of available property for sale.

9. The method of claim 4 wherein the buyer agent characteristics includes one or more of the following:
a) a buyer name and contact information; and
b) an amenity desired.

10. The method of claim 4 wherein the lending agent characteristics includes one or more of the following:
a) a lending agent name and contact information; or
b) a type of financing offered.

11. The method of claim 4 wherein the builder characteristics includes one or more of the following:
a) a builder name and contact information; or
b) an address of home built by builder.

12. The method of claim 1 wherein the network is the internet.

13. The method of claim 12 further comprising:
a) automatically updating the planned community data when the planned community source data changes by transmitting updated planned community data from a developer of the planned community to the database via the internet.

14. The method of claim 2 further comprising searching the data by one or more planned community characteristics.

15. The method of claim 14 further comprising searching the data by one or more available property characteristics.

16. The method of claim 14 further comprising searching the data by one or more listing agent characteristics.

17. The method of claim 14 further comprising searching the data by one or more owner characteristics.

18. The method of claim 14 further comprising searching the data by one or more buyer agent characteristics.

19. The method of claim 14 further comprising searching the data by one or more lending agent characteristics.

20. The method of claim 14 further comprising searching the data by one or more builder characteristics.

21. The method of claim 14 further comprising searching the data by one or more builder characteristics.

22. A database comprising:
a) planned community data, which further comprises planned community amenities;
wherein the database is searchable by planned community amenity.

23. A database comprising:
a) a planned community amenity of one or more planned communities;
b) available property characteristics for at least one property available in each of the planned communities;
c) listing agent characteristics for a listing agent holding a listing for at least one of the available properties in each of the planned communities;
d) owner characteristics for at least one of the available properties in each of the planned communities;
e) buyer agent characteristics for at least one of the available properties in each of the planned communities;
f) lending agent characteristics for at least one of the available properties in each of the planned communities; and
g) builder characteristics for at least one of the available properties in each of the planned communities.
wherein the database is searchable by planned community amenity.

24. A computer readable medium including instructions adapted to be executed by at least one processor to update the planned community data in the database of claim 23.
